(19) United States
(12) Patent Application Publication
(10) Pub. No.: US 2019/0201770 A1
(43) Pub. Date: Jul. 4, 2019

(54) Whistle Mount Assembly

(71) Applicant: Warren M. Werts, JR., Amherst, NY (US)

(72) Inventor: Warren M. Werts, JR., Amherst, NY (US)

(21) Appl. No.: 15/856,860

(22) Filed: Dec. 28, 2017

(51) Int. Cl. A63B 71/06; G10K 5/00

(52) U.S. Cl. CPC A63B 71/06; G10K 5/00

(57) ABSTRACT

A whistle mount assembly for continuously aligning a whistle with a mouth includes a head band that is worn around a head. A mount is coupled to the head band and the mount extends around a face when the head band is worn. Additionally, the mount is comprised of a rigid material. A whistle is coupled to the mount and the whistle is aligned with a mouth. Thus, the whistle is continuously positioned to be blown.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to mount devices and more particularly pertains to a new mount device for continuously aligning a whistle with a mouth.

### BRIEF SUMMARY OF THE INVENTION

An embodiment of the disclosure meets the needs presented above by generally comprising a head band that is worn around a head. A mount is coupled to the head band and the mount extends around a face when the head band is worn. Additionally, the mount is comprised of a rigid material. A whistle is coupled to the mount and the whistle is aligned with a mouth. Thus, the whistle is continuously positioned to be blown.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a whistle mount assembly according to an embodiment of the disclosure.

FIG. 2 is a perspective view of an embodiment of the disclosure.

FIG. 3 is a front in-use view of an embodiment of the disclosure.

FIG. 4 is a back in-use view of an embodiment of the disclosure.

### DETAILED DESCRIPTION OF THE INVENTION

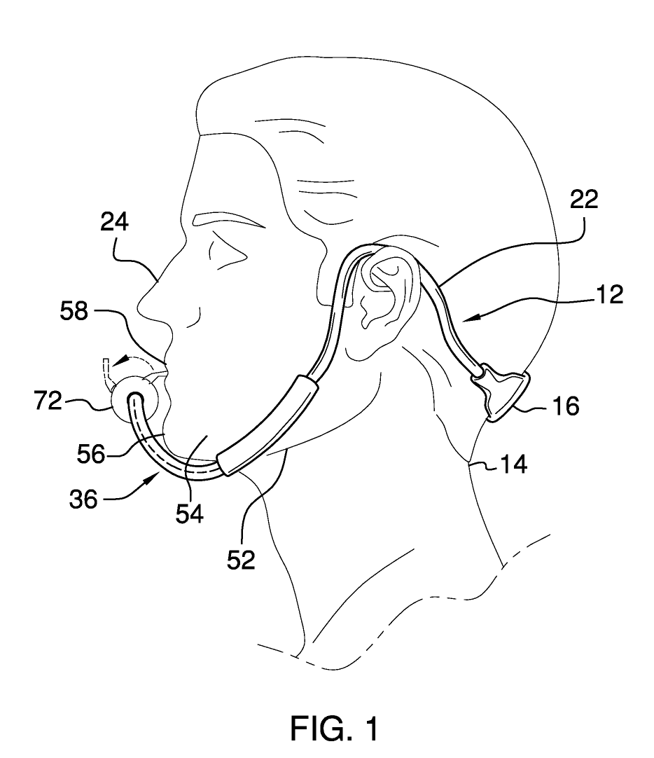

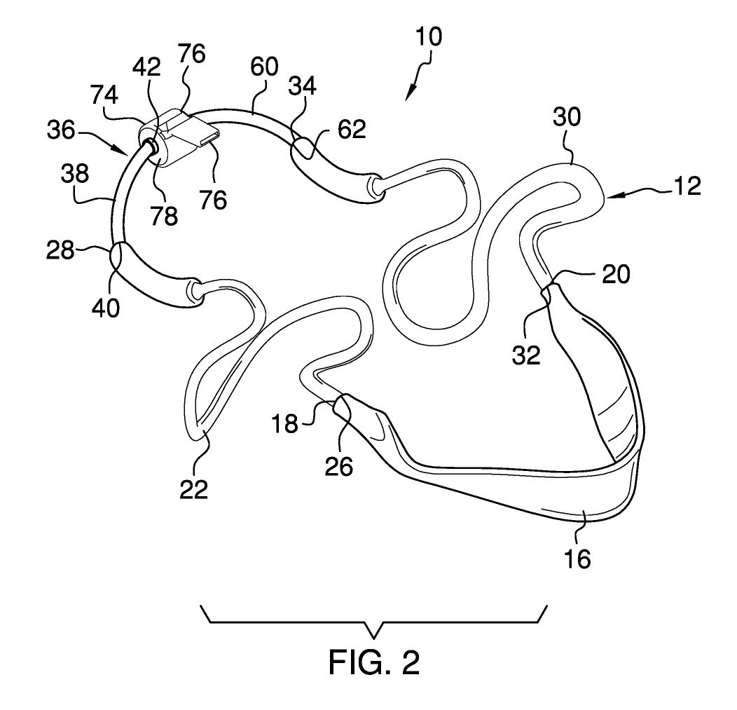

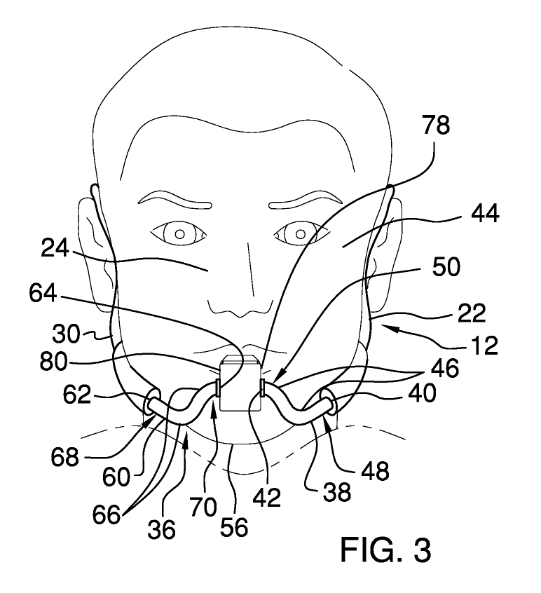

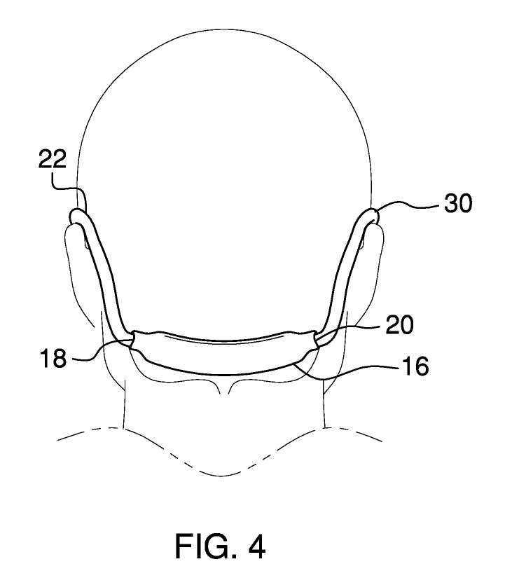

With reference now to the drawings, and in particular to FIGS. 1 through 4 thereof, a new mount device embodying the principles and concepts of an embodiment of the disclosure and generally designated by the reference numeral 10 will be described.

As best illustrated in FIGS. 1 through 4, the whistle mount assembly 10 generally comprises a head band 12 that may be worn around a head 14 of a user, such as a referee in a basketball game or other official in a sports event. The head band 12 comprises a strap 16 that is positioned on a back of a head or back of the head 14 when the head band 12 is worn. The strap 16 has a first end 18 and a second end 20.

A first band 22 is coupled to the strap 16 and the first band 22 extends along the side of the user's face 24 when the head band 12 is worn. The first band 22 has a first end 26 and a second end 28 and the first end 26 of the first band 22 is coupled to the first end 18 of the strap 16. A second band 30 is coupled to the strap 16 and the second band 30 extends along the side of an opposite side of the user's face 24 from the first band 22 when the head band 12 is worn. The second band 30 has a first end 32 and a second end 34 and the first end 32 of the second band 30 is coupled to the second end 20 of the strap 16. Each of the first band 22 and the second band 30 is comprised of a flexible material such as rubber tubing or the like.

A mount 36 is provided and the mount 36 is coupled to the head band 12. The mount 36 extends around the user's face 24 when the head band 12 is worn. Additionally, the mount 36 is comprised of a rigid material. The mount 36 includes a first member 38 that is coupled to the first band 22 and the first member 38 is positioned on the use's face 24 when the head band 12 is worn. The first member 38 has a primary end 40 and a secondary end 42 and the primary end 40 is coupled to the second end 26 of the first band 22. Moreover, the first member 38 is curved between the primary end 40 and the secondary end 42 such first member 38 curves around a front side 44 of the face 24.

The first member 38 has a sequence of bends 46 thereon and the bends 46 are spaced apart from each other. The bends 46 define a first portion 48 of the first member 38 that is oriented parallel to a second portion 50 of the first member 38. The first portion 48 extends away from the first band 22 along a lower edge 52 of the user's jaw 54. The second portion 50 is positioned above the user's chin 56 and the secondary end 42 is aligned with the user's mouth 58.

The mount 36 includes a second member 60 that is coupled to the second band 30 and the second member 60 is positioned on the user's face 24 when the head band 12 is worn. The second member 60 has a primary end 62 and a secondary end 64 and the primary end 62 of the second member 60 is coupled to the second end 34 of the second band 30. Additionally, the second member 60 is curved between the primary end 62 and the secondary end 64 of the second member 60 such that the second member 60 curves around the front side 44 of the user's face 24.

The second member 60 has a sequence of bends 66 thereon and the bends 66 on the second member 60 are spaced apart from each other. The bends 66 on the second member 60 define a first portion 68 of the second member 60 that is oriented parallel to a second portion 70 of the second member 60. The first portion 68 of the second member 60 extends away from the second band 30 along the lower edge 52 of the jaw 54. The second portion 70 of the second member 60 is positioned above the user's chin 56 and the secondary end 64 of the second member 60 is aligned with the user's mouth 58.

A whistle 72 is provided and the whistle 72 is rotatably coupled to the mount 36. Thus, the whistle 72 is continuously aligned with the user's mouth 58 when the head band 12 is worn thereby facilitating the whistle 72 to be blown. The whistle 72 has a housing 74 and a mouthpiece 76 and the housing 74 has a first lateral side 78 and a second lateral side 80. The secondary end 42 of the first member 38 is rotatably coupled to the first lateral side 78 and the secondary end 64 of the second member 60 is rotatably coupled to the second lateral side 80. Moreover, the whistle 72 may be a referee's whistle of any conventional design.

In use, the head band 12 is worn during officiating of the sports event. Each of the first band 22 and the second band 30 are extended over the official's ears. The mount 36 is manipulated to align the whistle 72 with the official's mouth 58. Thus, the whistle 72 may be blown immediately upon the official observing a foul, or the like, without loosing the time required to grip and position a conventional whistle 72 in the official's mouth 58. Thus, the official makes more efficient use of the time on the clock of the sports event.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A whistle mount assembly being configured to be worn around the head thereby facilitating a whistle to be readily available for blowing, said assembly comprising:
a head band being configured to be worn around a head;
a mount being coupled to said head band wherein said mount is configured to extend around a face when said head band is worn, said mount being comprised of a rigid material; and
a whistle being coupled to said mount wherein said whistle is configured to be aligned with the mouth thereby facilitating said whistle to be blown.

2. The assembly according to claim 1, wherein said head band comprises a strap being configured to be positioned on a back of a head, said strap having a first end and a second end.
said strap has a first end and a second end; and
said first band has a first end and a second end, said first end of said first band being coupled to said first end of said strap, said first band being comprised of a flexible material.

3. The assembly according to claim 2, further comprising a first band being coupled to said strap wherein said first band is configured to extend along the side of a face, said first band has a first end and a second end, said first end of said first band being coupled to said first end of said strap, said first band being comprised of a flexible material.

4. The assembly according to claim 2, further comprising a second band being coupled to said strap wherein said second band is configured to extend along the side of a face, said second band having a first end and a second end, said first end of said second band being coupled to said second end of said strap, said second band being comprised of a flexible material.

5. The assembly according to claim 3, wherein said mount comprises a first member being coupled to said first band wherein said first member is configured to be positioned on a face said first member having a primary end and a secondary end, said primary end being coupled to said second end of said first band.

6. The assembly according to claim 5, wherein said first member is curved between said primary end and said secondary end wherein said secondary end is configured to be aligned with a mouth.

7. The assembly according to claim 6, wherein said first member has a sequence of bends thereon, said bends being spaced apart from each other to define a first portion of said first member being oriented parallel to a second portion of said first member, said first portion extending away from said first band wherein said second portion is configured to be positioned on the face.

8. The assembly according to claim 3, further comprising a second member being coupled to said second band wherein said second member is configured to be positioned on a face, said second member having a primary end and a secondary end, said primary end of said second member being coupled to said second end of said second band.

9. The assembly according to claim 8, wherein said second member is curved between said primary end and said secondary end of said second member wherein said secondary end of said second member is configured to be aligned with a mouth.

10. The assembly according to claim 9, wherein said second member has a sequence of bends thereon, said bends on said second member being spaced apart from each other to define a first portion of said second member being oriented parallel to a second portion of said second member, said first portion of said second member extending away from said second band wherein said second portion of said second member is configured to be positioned on the face.

11. The assembly according to claim 10, wherein said whistle has a housing and a mouthpiece, said housing having a first lateral side and a second lateral side, said secondary end of said first member being coupled to said first lateral side, said secondary end of said second member being coupled to said second lateral side.

12. A whistle mount assembly being configured to be worn around the head thereby facilitating a whistle to be readily available for blowing, said assembly comprising:
a head band being configured to be worn around a head, said head band comprising:
a strap being configured to be positioned on a back of a head, said strap having a first end and a second end;
a first band being coupled to said strap wherein said first band is configured to extend along the side of a face, said first band has a first end and a second end, said first end of said first band being coupled to said first end of said strap, said first band being comprised of a flexible material;
a second band being coupled to said strap wherein said second band is configured to extend along the side of a face, said second band having a first end and a second end, said first end of said second band being coupled to said second end of said strap, said second band being comprised of a flexible material;
a mount being coupled to said head band wherein said mount is configured to extend around a face when said head band is worn, said mount being comprised of a rigid material, said mount comprising:
a first member being coupled to said first band wherein said first member is configured to be positioned on a face said first member having a primary end and a secondary end, said primary end being coupled to said second end of said first band, said first member being curved between said primary end and said secondary end wherein said secondary end is configured to be aligned with a mouth, said first member having a sequence of bends thereon, said bends being spaced apart from each other to define a first portion of said first member being oriented parallel to a second portion of said first member, said first portion extending away from said first band wherein said second portion is configured to be positioned on the face; and
a second member being coupled to said second band wherein said second member is configured to be positioned on a face said second member having a primary end and a secondary end, said primary end of said second member being coupled to said second end of said second band, said second member being curved between said primary end and said secondary end of said second member wherein said secondary end of said second member is configured to be aligned with a mouth, said second member having a sequence of bends thereon, said bends on said second member being spaced apart from each other to define a first portion of said second member being oriented parallel to a second portion of said second member, said first portion of said second member extending away from said second band wherein said second portion of said second member is configured to be positioned on the face; and
a whistle being coupled to said mount wherein said whistle is configured to be aligned with the mouth thereby facilitating said whistle to be blown, said whistle having a housing and a mouthpiece, said housing having a first lateral side and a second lateral side, said secondary end of said first member being coupled to said first lateral side, said secondary end of said second member being coupled to said second lateral side.
